(19) United States
(12) Patent Application Publication
(10) Pub. No.: US 2024/0050857 A1
(43) Pub. Date: Feb. 15, 2024

(54) USE OF AI TO MONITOR USER CONTROLLER INPUTS AND ESTIMATE EFFECTIVENESS OF INPUT SEQUENCES WITH RECOMMENDATIONS TO INCREASE SKILL SET

(71) Applicants: Sony Interactive Entertainment LLC, San Mateo, CA (US); Sony Interactive Entertainment Inc., Tokyo (JP)

(72) Inventors: Benaisha Patel, San Mateo, CA (US); Morgan Fryer-McColloch, San Mateo, CA (US); Celeste Bean, San Mateo, CA (US)

(21) Appl. No.: 17/887,352

(22) Filed: Aug. 12, 2022

(51) Int. Cl. A63F 13/67

(52) U.S. Cl. CPC A63F 13/67

(57) ABSTRACT

Methods and systems for providing assistance to a user for playing a video game includes identifying attributes of inputs of the user from prior gameplays of the video game. The attributes are analyzed to identify input capabilities of the user. Skills required to progress in the video game are identified and hints are provided to the user to guide the user to obtain certain ones of the skills. The obtained skills assist the user to progress in the video game.

### TECHNICAL FIELD

The present disclosure relates to monitoring user inputs to a video game, and more particularly to estimate input effectiveness and provide assistance to increase skill set of a user for playing the video game.

### BACKGROUND OF THE DISCLOSURE

With the growing number of video games available to a user, it is hard for the user to remember details of each and every video game the user has played and will be playing. A user can play a number of games at different times. In one instance, a user playing a video game either by themselves (i.e., in case of single-player game) or with other players (i.e., multi-player game) may elect to pause the gameplay, and continue the gameplay at a different time. In a multi-player game, the decision to pause may be made by the player or by a majority of players. In such instances, the user and/or the players may decide to resume their gameplay of the video game at a later time. Alternately, in a single-player game, the user may pause the gameplay of the video game and return to resume their gameplay from a point where they left off or re-start from the beginning. In either of these cases, when the user returns to resume or re-start gameplay of a video game, the user may forget certain parts of the video game, such as goals, or purpose, or gameplay moves, types of inputs and/or user customizations, game assets needed, etc.

It is in this context that the invention arises.

### SUMMARY

Implementations of the present disclosure relate to systems and methods for detecting a user's interest in gameplay of a video game, identifying the user's input capabilities to determine a type of assistance that has to be provided, and timely providing the assistance to the user to allow the user to progress in the video game. The assistance provided to the user can include details of inputs required, sequence of inputs, speed at which the inputs need to be provided, context or purpose or goals of the video game, information related to game assets required to progress in different levels and how the game assets can be acquired, etc. The assistance provided to the user can be customized in accordance to the user's capabilities so that the user does not get overwhelmed with the assistance. The assistance can be provided as hints specifying the type, sequence, combination of inputs needed, story points of the video game to allow the user to recollect the purpose, goal, context, etc., of the video game, game assets (e.g., game weapons) needed, game moves needed, etc., to accomplish a certain challenge or a level in the video game. These hints can be provided on a user interface or can be delivered in different forms, including but not limited to visual, aural, haptic, textual, images, instructional videos, etc.

In some implementations, the hints can be provided by predicting what game asset or game skill is needed in a later portion of the video game, and identifying one or more earlier portions of the video game where the game asset or game skill can be acquired by the user. For example, a game asset may be needed to progress in level 5 of a video game and the game asset can be acquired in either level 2 or 3. The game asset may have been found to be very effective in overcoming a certain challenge in level 5 (e.g., defeating a monster, or jumping over a bridge, etc.). The system is configured to predictively determine the need of the game asset in level 5, and check to see if the user is in possession of the game asset. If the user is in possession of the game asset, the system proactively provides hints to the user to acquire the game asset when they are interacting in level 2 and in level 3. Other types of hints can also be provided to the user to assist the user to progress in the game.

By providing hints to the user, the user is able to recollect specific details of the video game, skills that they are lacking, skills that are needed, etc., so that they are able to acquire the skills to progress in the game. As the user progresses in the video game, their interest in the video game increases, leading to improved user engagement. Improving user engagement in a video game is a goal of every video game developer.

In one implementation, a method for providing assistance to a user for playing a video game is disclosed. The method includes identifying attributes of inputs provided by the user during prior gameplay sessions of a plurality of video games. The attributes are identified by analyzing the inputs retrieved from historical game data of the user. The attributes of the inputs are used to identify input capabilities exhibited by the user during the prior gameplay sessions of the plurality of video games. Progression of the user in the video game is tracked during a current gameplay session to identify a current level of the user in the video game and the inputs provided by the user during the current gameplay session. Skills required for the user to progress to each levels of the video game are predicted based on the input capabilities of the user, the input requirements specified for each level of the video game, and inputs provided by the user in current gameplay session. Hints are provided to guide the user to obtain certain ones of the skills at the current level of the video game to assist the user to progress in the video game. The hints are customized in accordance to the input capabilities of the user and a game state of the video game in the current gameplay session.

In another implementation, a method for providing assistance to a user for playing a video game is disclosed. The method includes identifying attributes of inputs provided by the user during prior gameplay sessions of a plurality of video games. The attributes are identified by analyzing the inputs retrieved from historical game data of the user, wherein the plurality of video games includes the video game. The attributes of the inputs are analyzed to determine input capabilities exhibited by the user during prior gameplay sessions of the plurality of video games. A specific area of gameplay of the video game is identified where the user requires assistance to progress in the video game, based on the input capabilities of the user. Hints are provided to assist the user to progress in the specific area of gameplay of the video game. The hints are customized in accordance to the input capabilities of the user and based on a game state of the video game in the current gameplay session.

Other aspects and advantages of the disclosure will become apparent from the following detailed description, taken in conjunction with the accompanying drawings, illustrating by way of example the principles of the disclosure.

### BRIEF DESCRIPTION OF THE DRAWINGS

The disclosure may best be understood by reference to the following description taken in conjunction with the accompanying drawings.

FIG. 1 provides a simplified block diagram of a system that engages user guidance engine that is used to provide guidance to a user to progress in a video game, in accordance with one implementation of the present disclosure.

FIG. 2 illustrates various modules of a user guidance engine used for detecting the skills required by the user to progress in the video game and providing guidance to acquire the required skills, in accordance with one implementation of the present disclosure.

FIGS. 3A and 3B illustrate sample matrices of user skills and required game skills generated by the user guidance engine to identify skills that the user is lacking and requires to progress in the video game, in accordance with one implementation of the present disclosure.

FIGS. 4A-4D illustrate different ways adopted by the user guidance engine to provide hints to the user to acquire a required skill for progressing in the video game, in accordance with some implementations of the present disclosure.

FIG. 5 illustrates a simplified flow of operations of a method for verifying a digital twin of a real-world object in possession of a user, in accordance with one implementation of the present disclosure.

FIG. 6 illustrates components of an example computing device that can be used to perform aspects of the various implementations of the present disclosure.

### DETAILED DESCRIPTION

In the following description, numerous specific details are set forth in order to provide a thorough understanding of the present disclosure. It will be apparent, however, to one skilled in the art that the present disclosure may be practiced without some or all of these specific details. In other instances, well known process steps have not been described in detail in order not to obscure the present disclosure.

As more and more video games are being made available to a user, the user is able to select a plurality of video games for gameplay at different times. The video games can be single-player games or multiplayer games. As the number of video games played by the user increases, the user has to keep track of details of various games, including context and purpose, types, speed, sequence, combination of inputs, user customizations of controls, etc., for the various games so they can have a satisfactory gameplay experience with each of the video games. Due to shear number of video games the user is engaged in, the user may sometimes forget different things about the game, including but not limited to, purpose, goals, story points, weapons required, types of inputs, sequence of inputs, combination of inputs from one or more input devices, etc. Further, in some cases, the user may not be able to perform certain ones of inputs to progress in the game. For example, the user may not be able to provide certain types of inputs, such as double click, fast enough for the system to recognize, or remember the correct sequence of inputs needed to accomplish a task, or remember the customizations or the specific type of input devices that has to be used to provide the inputs, etc.

In order to keep the user engaged and to allow the user to have satisfactory gameplay experience, systems and methods are disclosed to provide assistance to the user for playing a video game. Inputs provided by the user for different video games during prior gameplay sessions are collected and analyzed to determine the user's skills. The skills possessed by the user represent the input capabilities of the user. The input capabilities can be related to game assets and/or input devices owned and operated by the user to provide inputs, and skills shown in operating input devices of the user. For instance, the input capabilities can include type and number of game assets and input devices owned and operated by the user to provide inputs, and the user's mastery for maneuvering the different types of game assets and input devices for providing the inputs to the video games. The skills for maneuvering input devices depend on type of input device(s) used to provide inputs, and the skills that can be exhibited by the user maneuvering the input devices include speed of input, sequence of input, combination of inputs using one or a combination of input devices, etc. In addition to identifying the skills exhibited by the user, the skills required for progressing in the video game are identified. The skills required for progressing in each level of the video game can be obtained from details provided in the game logic. For example, the game logic identifies what inputs are needed to overcome challenges or achieve goals defined in each level of the video game. Further, the details provided in the game logic can be used to predict what skills are required in later level of the video game but are available in one or more earlier levels of the video game. Based on the skills (i.e., input capabilities) of the user and skills required for progressing in the different levels of the video game, assistance is provided in the form of hints. The hints provided to the user are customized in accordance to the skills possessed by the user. The hints guide the user in obtaining the necessary skills to progress in each level of the video game. The customized hints assist the user to recollect details of the video game and the inputs that are required and guide the user on the type of input devices to use and type of inputs to provide using the input device. This personalized feedback based on the skill set of the user allows the user to continue to engage in the video game, thereby increasing user interest in the video game.

With the general understanding of the disclosure, specific implementations will be described with reference to the various drawings.

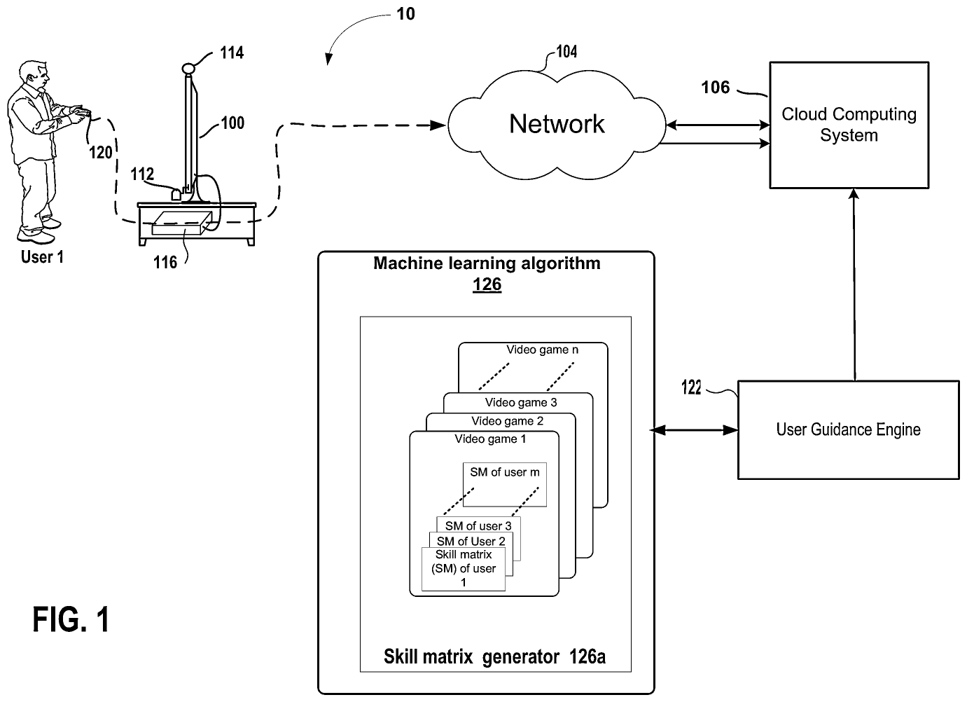

FIG. 1 illustrates an implementation of a system 10 for providing assistance to a user (user 1) of a video game. In some implementations, the video game can be executing on a game console 116 and user 1 can be interacting with the video game by providing inputs from one or more input devices, such as game controller 120, mouse 112, keyboard (not shown), etc. The inputs provided by the user are used to affect a game state of the video game and to generate game content showing the current game state. The generated game content is forwarded to a display screen 100 associated with the user, for rendering. In alternate implementations, the video game can be executing on a server (not shown) of a cloud computing system 106 via a network 104. In such implementations, the inputs provided by the user using the input devices can be routed through the game console 116 to the server and the game content generated from the inputs is forwarded to the game console 116 for rendering on a display device coupled to the game console 116. In alternate implementations, the input devices can be directly coupled to the server of the cloud computing system 106 via the network 104 and the inputs from the input devices are directly transmitted to the server for affecting the game state of the video game executing on the server. Content of the video game generated at the server are transmitted to the game console 116 for rendering at the display screen.

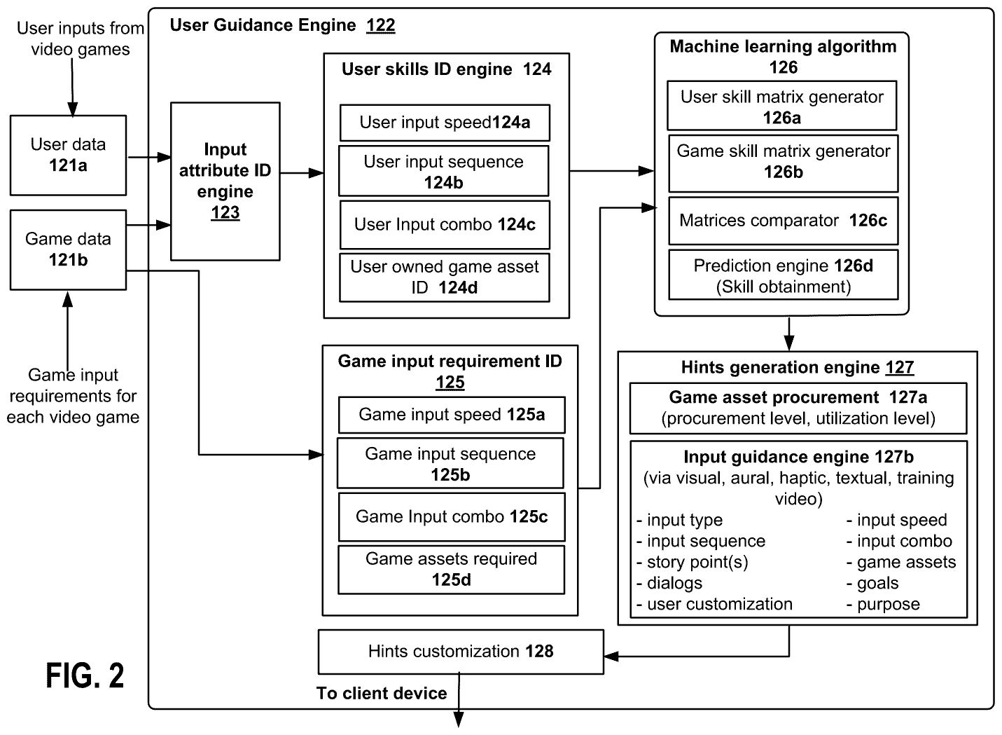

A user guidance engine 122 executes on a server of the cloud computing system 106 and is configured to detect the skill set of the user and to provide guidance in accordance to the skill set of the user. In some implementation, the user guidance engine 122 is configured to execute on the same server on which the video game is executing and data from the video game is used by the user guidance engine 122 along with other data to identify skill set of the user, skills required in the game for accomplishing each level of the video game, and skills that the user is lacking and needs to accomplish challenges and tasks at each level of the video game. The skill set of the user and the required skills for each level of the game are used to generate respective skill matrices (i.e., user skills matrix, required game skills matrix) using a skill matrix generator 125a within machine learning algorithm 125. The two matrices are compared to identify the skills that the user needs to progress in each level of the video game. The user guidance engine 122 then uses the results from the comparison to identify skills that the user needs and generates appropriate hints to acquire the skills. Details of the various modules and functions of each module will be described in detail with reference to FIG. 2.

FIG. 2 illustrates an example user guidance engine 122 with a plurality of modules to determine skill set of a user, identify skills that the user are required but does not yet own, in order to accomplish challenges in each level, and provide hints to assist the user to obtain the skills and progress in the video game. Broadly speaking, some of the modules included in the user guidance engine 122 include a input attribute identification engine 123, user skills (i.e., input capabilities) identification engine 124, game input requirement identification engine 125, machine learning algorithm 126 and hints generation engine 127. The list of modules is provided as a mere example and fewer or greater number of modules and/or additional modules can also be envisioned.

The user guidance engine 122 detects a user accessing a video game at the game cloud system. In response, the user guidance engine 122 validates the user. User validation can include verifying authenticity of the user and verifying that the video game accessed by the user is one of the video games that the user is authorized to access. After successful authentication of the user and the verification of the video game accessed by the user, the user guidance engine 122 queries a user database 121a and receives user input data associated with the user. The user input data stored in the user database 121a includes inputs provided by the user during prior gameplay sessions of different video games. In some implementations, the user guidance engine 122 only retrieves the user input data associated with the video game captured during prior gameplay sessions of the video game. The retrieved user input data provides sufficient details that can be used to determine the skills (i.e., input capabilities) exhibited by the user in the video game. In alternate implementations, the user guidance engine 122 queries and receives the user input data of the user collected from prior gameplay sessions of a plurality of video games.

In some implementations, the user may be accessing the video game for the first time. As a result, there may not be any user input data available for the video game. In such cases, the user input data of the user is retrieved for the plurality of video games that the user accessed and played during prior gameplay sessions. The retrieved user input data is used to determine the skills of the user. In some other implementations, the user may not have played any video game previously and this would be their first time accessing a video game for gameplay. In such implementations, the user guidance engine 122 can detect that there is no user input data for the user in the user database 121a. Consequently, the user guidance engine 122 retrieves the user profile of the user, analyzes the user profile to identify user's attributes, and matches the user's attributes with other users (i.e., players) who have played the video game that the user is trying to access for gameplay or a plurality of video games. Select ones of the users are identified from the user attribute matching. The user guidance engine 122 then queries and retrieves user input data of thee select ones of the users for the video game or the plurality of video games, and uses the retrieved user input data for providing guidance to the user for navigating and progressing in the video game.

The user input data retrieved from prior gameplay sessions of the video game or of a plurality of video games, is analyzed to identify the various input attributes. An input attribute identification engine 123 is engaged by the user guidance engine 122 to analyze the user input data and identify the input attributes of the user and/or of other users. The input attributes of the user/plurality of users obtained from prior gameplay sessions of the video game/a plurality of video game provide sufficient historical details to understand the specific skills exhibited by the user/plurality of users as they were navigated the video game/plurality of video games during prior gameplay sessions. For example, the identified input attributes can include type and details of video game associated with each user input, type of input devices used to provide the inputs, type of inputs provided, including speed, sequence/combination of inputs, etc., as the user(s) navigated through the various levels of the video game(s). These identified input attributes of the user(s) from the video game(s) can be used to determine a user's comfort level in operating various input devices, ease at which the user is able to operate more than one input device simultaneously to provide the inputs, a speed at which the user is able to provide inputs or combination/sequence of inputs, the user's ability to remember and reproduce certain sequence or combination of inputs using a single or multiple input devices, etc. In addition to the user's exhibited skills for providing the inputs, the details from the user input data can be used to determine if the user is able to recall story points, goals, purposes, game assets (e.g., weapons, etc.) needed for navigating in the video game, etc. Such details can be determined, for example, based on the way the user is providing their inputs—e.g., pressing multiple or random buttons on a keyboard or an input device, moving in random directions within the video game, pausing to determine a navigation direction, standing still and not providing any input during a highly intense portion of the video game, etc.

Input attribute details identified by the input attribute identification engine 123 is forwarded as input to the user skills identification engine 124 for further processing. The user skills identification engine 124 sorts the input attribute details of the user(s) to identify appropriate user input categories, such as user input speed 124a, user input sequence 124b, user input combo 124c, user owned game asset identification 124d, to name a few. The various user input categories are then forwarded as input to machine learning algorithm 126 for further processing.

In addition to analyzing the user inputs, the user guidance engine 122 retrieves and processes the game input requirements for the video game to understand the gameplay requirements specified in the game logic of the video game in order for the user to progress in the video game. The gameplay requirements can specify the specific skills that are expected from the user to allow the user to progress in the video game. A game input requirement identification engine 125 is used to identify the appropriate game logic of the video game, and to query and retrieve the game input requirements detailed in the identified game logic. The game input requirements can be analyzed to identify specific game input speed 125a, game input sequence 125b, game input combination 125c, game assets required 125d, etc., required when providing each input or for each challenge in a level of a game. In some implementations, the game logic can specify more than one set of game inputs that can be provided by a user to achieve a particular goal within a game level of the video game, wherein each set can specify inputs that are distinctively different from the other sets. The game input requirement details identified by the game input requirement identification engine 125 are also provided to the machine learning algorithm 126 for further processing.

The machine learning algorithm 126 uses the game input skills of the user and the game input requirements of the video game to build corresponding skill matrices, in one implementation. For instance, when the game input skills of the user are available for prior gameplay sessions of the video game, the machine learning algorithm 126 engages a user skill matrix generator 126a to use the identified game input skills of the user in various levels of the video game to generate user skill matrix. The user skill matrix identifies the various levels of the video game and the various tasks/challenges that have to be overcome by the user in each level to progress in the video game. The number of levels in the user skill matrix may or may not match the number of levels available in the video game. For example, if the user was able to only complete certain number of levels of the video game due to game complexity, then the number of levels that is included in the generated user skill matrix of the user correspond to the number of levels the user was able to accomplish. If, however, the user was able to complete all the levels of the video game, then the number of levels in the generated user skill matrix of the user will be equal to the number of levels in the video game. Similarly, a number of tasks in each level may or may not match the number of tasks included in each level. For example, the game logic may indicate that when the user completes a certain number of tasks in a certain level, the user can progress to a next level in the video game, wherein the certain number of tasks can be less than the number of tasks that are made available to the user in the certain level.

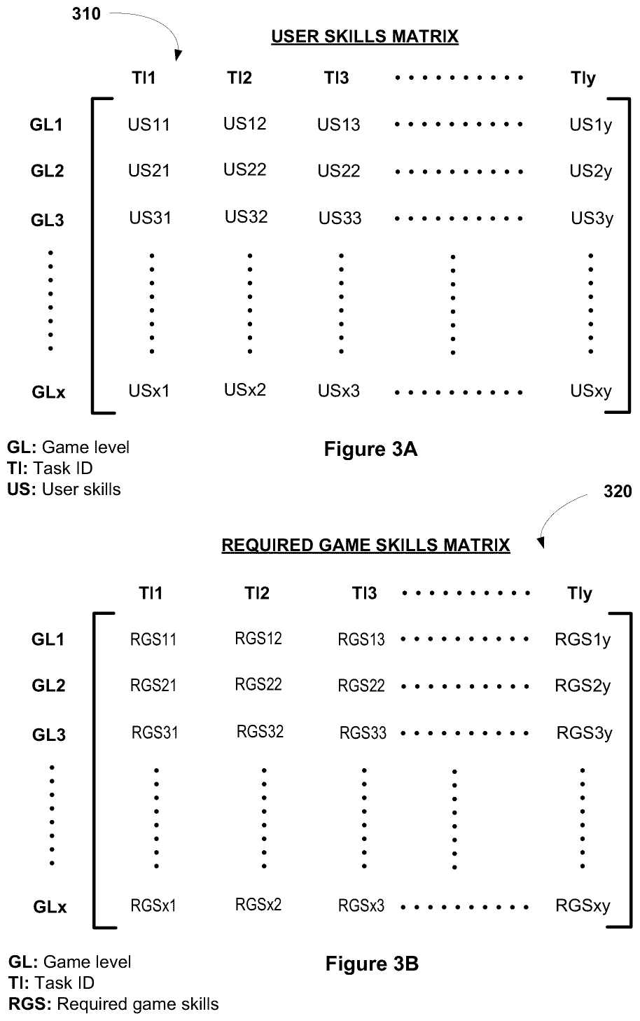

FIG. 3A illustrates one example of user skill matrix 310 generated for a user of a video game. The user skill matrix 310 is generated to include the skills exhibited by the user in accomplishing the various tasks defined in each game level attempted and accomplished by the user during prior gameplay sessions of the video game. The skills identify the input capabilities of the user. The user skill matrix 310 is shown to be an (x,y) matrix, with an ‘x’ number of game levels identified for the video game represented along the rows and a ‘y’ number of tasks identified in each level represented along the columns. The relevant skills of the user(s) exhibited when attempting/accomplishing the various tasks in different levels of the video game(s) are used to update the relevant entries/elements of the user skill matrix 310.

Referring back to FIG. 2, the machine learning algorithm 126 uses the game skills required for accomplishing the various tasks in different game levels, as specified in the game logic, to generate a required game skills matrix 320. The game skills matrix 320, as with the user skill matrix 310, is represented as a (x,y) matrix with the game levels represented in ‘x’ number of rows, and the tasks represented in ‘y’ number of columns and the game skills required to accomplish each task represented as a corresponding entry in the required game skills matrix 320. Unlike the user skill matrix where the number of rows and columns may or may not represent the actual number of game levels and tasks, the number of rows in the required game skills matrix 320 correspond with the actual number of game levels that are in the video game, and the number of columns represent the actual number of tasks in each game level of the video game.

FIG. 3B illustrates one such representation of required game skills matrix 320 generated for the video game. As noted above, the required game skills matrix 320 includes ‘x’ number of game levels and ‘y’ number of tasks with the required skills to accomplish each task updated to each entry of the game skills matrix 320.

Referring back to FIG. 2, once the respective matrices have been generated, the machine learning algorithm determines the skills currently possessed by the user, the game skills required by the game logic to accomplish the various tasks, and identifies skills that the user is lacking or needs in order to be able to accomplish the various tasks. A matrices comparator 126c is used to compare the user skills matrix 310 against the game skills matrix 320 to identify the skills that the user needs to acquire to enable the user to accomplish the task(s). The matrices comparator 126c, in one implementation, “overlays” the user skills matrix 310 over the game skills matrix 320 of the video game to identify differences between the game-required and the user-owned skills. In some implementations, the “overlay” is accomplished by identifying an entry for a particular task in a particular game level in both the matrices (310, 320) and comparing the game-required skills with the user-owned skills to identify any additional skills that need to be acquired by the user prior to attempting the task.

Once the additional skills have been identified, in some implementations, by the matrices comparator 126c, the machine learning algorithm 126 may engage a prediction engine 126d to determine where, when and how the additional skills can be acquired by the user. The prediction engine 126d receives details of the additional skills required by the user to accomplish a certain task, as identified by the matrics comparator 126c, and uses the details of the video game obtained from game database 121b to identify the game levels where the additional skills can be acquired. In some implementations, the additional skills required can be a game asset. In these implementations, the prediction engine 126d uses the game asset identifier to identify one or more game levels where the identified game asset is available for the user to acquire. For example, the prediction engine 126d can predictively identify a specific game weapon required for effectively defeating a monster in game level 5. Using the predictive knowledge of the specific game weapon required in game level 5, the prediction engine 126d then identifies game levels (e.g., game levels 1 and 2—i.e., earlier game level) prior to game level 5 (i.e., later game level) where the specific game weapon is available for user acquisition. The specific game weapon can be available for purchase at other game levels that are later than the game level 5 (e.g., at game levels 7-10). However, identification of these game levels (game levels 7-10) is not useful as these game levels occur later in the video game than game level 5. In addition to identifying the earlier game levels for acquiring the specific game weapon, the prediction engine can specify how the user can obtain the specific game weapon. For example, the specific game weapon can be acquired through purchase or by performing a certain task (e.g., defeat a user, trade another game asset for the specific game asset, etc.).

Information from the prediction engine 126d identifying the specific skills required by the user and the details of where, when and how the user can acquire the specific skills, are provided to a hints generation engine 127. In some implementations where the information is related to acquiring a game asset, the hints generation engine 127 uses the information to provide hints to the user at appropriate times to guide the user in obtaining the specific skills for progressing in the video game. For example, the hints generation engine 127 engages a game asset procurement engine 127a to use the information provided by the prediction engine 126d to provide a hint to the user when the user is interacting in game level 1 or 2 (i.e., an earlier game level or procurement level), wherein the hint is an informational message instructing the user that the specific game weapon required in game level 5 (i.e., a later game level or utilization level) is available in game level 1 or 2 (i.e., an earlier game level or procurement level). The hints can be provided in different formats. For example, the hints can be provided in textual, aural, haptic, for graphical format.

In alternate implementations where the information is related to the way the inputs need to be provided by the user to progress in the video game, the hints can be provided to guide the user to provide the appropriate inputs. For example, a certain task of the video game may require the user to provide their inputs in a specific sequence, specific combination, specific types, using specific input device, etc., and the hints are provided to guide the user to provide the required inputs. An input guidance engine 127b is used to generate appropriate signals to the user with hints on how to provide the appropriate inputs. For example, the required inputs may include a particular input type (e.g., double click, double click followed by another double click, etc.), input speed (e.g., button press speed, etc.), input sequence, input combination (e.g., a combination of button presses, clicks and/or swipes on interactive surface available in a single input device or multiple input devices).

In other implementations where the information is related to details of video game, the hints may be provided to include recollection metrics, such as story points, goals, purposes, dialogs between the user and other players, user and spectators, user and coach, user and sponsor, etc., game assets available, user customization provided for the video game, to allow the user to recollect the relevant points of the video game. As the user engages in more and more video games, it can be hard for the user to remember the details of the different video games. When the user forgets the purpose or goals or the story points, etc., the user can make mistakes or struggle to provide appropriate inputs, leading to frustration and loss of interest in the video game. To avoid such issues, the user is provided with hints including the game details, game inputs expected, etc., so that the user can follow the hints and provide the appropriate inputs to progress in the video game. In some implementations, the user can get frustrated when they forget the sequence or combination of inputs required for the user to accomplish a task in a certain level of the video game. The hints are provided to the user to guide the user in providing the appropriate inputs.

The input guidance engine 127b can provide the hints in various different formats and use different components of a client device of the user to provide the hints. For example, the hints can be provided to the user in a visual format by lighting up the appropriate button(s) on a controller (i.e., input device), for example, for the user to follow. Alternately, the visual hints can be provided in images of different input controls rendered on a display screen associated with a client device of the user with different input controls lighted up in appropriate sequence. The client device can be a mobile computing device, a laptop computing device, a desktop computing device, or a wearable computing device, the display screen can be a TV monitor or screen or surface associated with or coupled to the client device. Alternately, the hints can be provided aurally using speaker on a game controller, a head mounted display, a monitor, or a computing device, etc. The hints can also be provided haptically by sending haptic signals to appropriate input controls of an input device, or textually for rendering on a display screen associated with an input device or the client device. The hints can also be provided in the form of training videos.

In some implementations, the hints generated by the hints generation engine 127 is customized in accordance to the user's input capabilities and forwarded to an appropriate component of the client device of the user for rendering. For example, the user may not be capable of providing the inputs at a required speed for the video game to recognize such inputs. In such implementations, the user input customization may be defined to take into account the user's inability to provide inputs at or beyond a certain speed, and the hints provided to the user are adjusted accordingly to take into consideration the speed that the user is comfortable with when providing the hints. By recognizing the user's capabilities when providing the hints allows the user to gain confidence in providing the inputs, leading to longer engagement of the user in the video game. Longer engagement can lead to greater revenue for the game developer.

In some implementations, an option can be provided to the user on a user interface to enable and disable the hints provided to the user. In some implementations, the user may wish to disable the hints as they want to be challenged, even when they are struggling with the challenges. In other implementations, the user may not want the hints up to a certain level and once they are beyond that level, they may want the hints to help them navigate some of the challenges in the levels beyond the certain level. In some implementations, the user may want to control on the frequency (i.e., less frequently or more frequently) and/or aggressiveness (i.e., less aggressive or more aggressive) of the hints provided to the user. To provide the user with more control on how the hints are provided to the user, the hints customization engine 128 may provide a user interface with selection options to allow the user to select the appropriate options so that the hints provided to the user can be customized in accordance to how the user wants and needs.

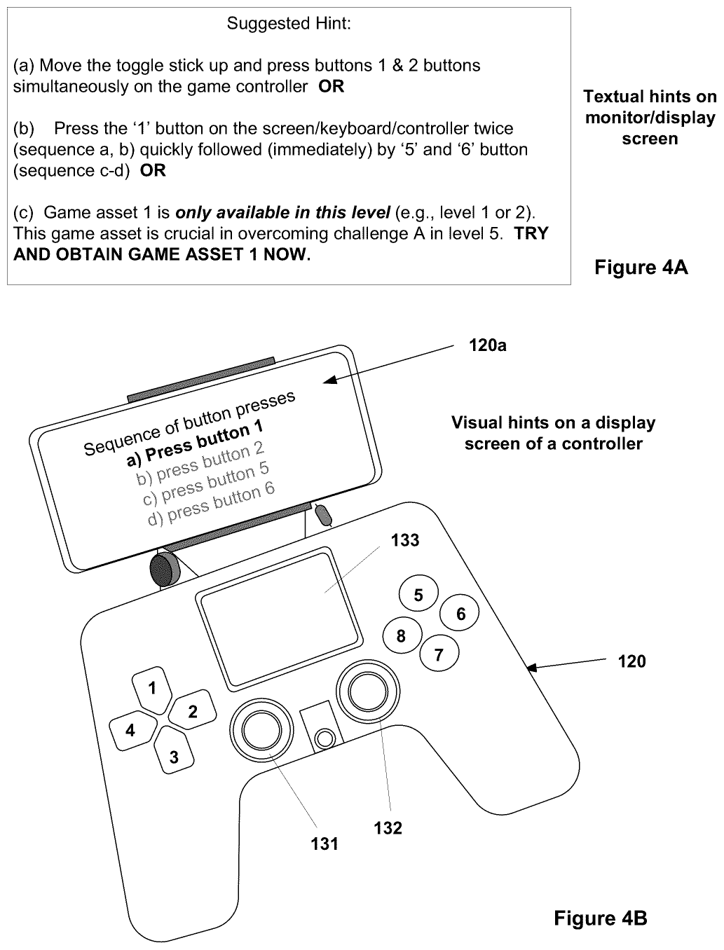

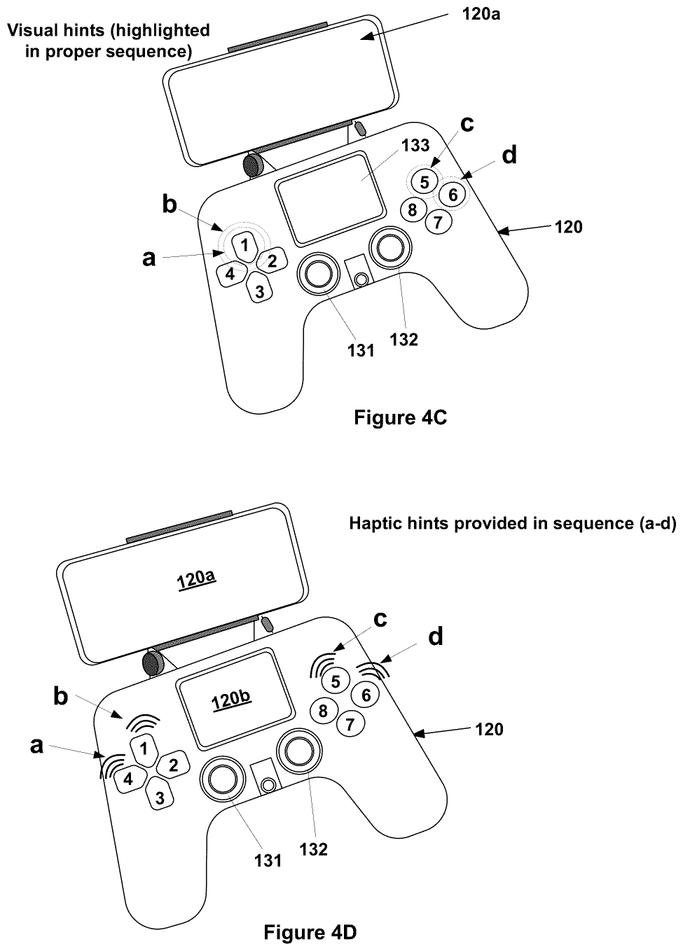

FIGS. 4A-4D illustrate some examples of the type of hints and the different formats/devices that can be used to provide the hints, in some implementations. FIG. 4A illustrates an example hint provided in textual format for rendering on a display screen associated with a client device of the user, in one implementation. The textual hint can be related to a type of user input(s) expected or informative message as shown in suggested hint ‘a’ or ‘b’, or for acquiring a game asset as shown in suggested hint ‘c’. FIG. 4B illustrates an alternate implementation where the hints are provided in a visual format on a display screen 120a associated with a controller (e.g., input device) 120. The controller 120 is shown to include the display screen 120a, a right and left analog input control (131, 132), a touch screen interface 133, and a plurality of input controls 1-8. The controller 120 illustrated in FIG. 4B is provided as an example and should not be considered restrictive. Fewer or additional input controls can be provided on the controller 120 to allow the user to provide inputs. The hint is provided in visual format by highlighting each textual hint in sequence to grab the user's attention. In the illustrated of FIG. 4B, a first textual hint ‘a’ is first highlighted for the user to follow. Upon detecting the user complying with the first visual hint, the first textual hint ‘a’ is greyed out and the second textual hint ‘b’ is highlighted. In this manner, the hints generation engine 127 ensures that the user follows the hints to accomplish their goal in a specific level of the game for which the hints are provided.

FIG. 4C illustrates another example of visual hints provided to the user using input controls of an input device, such as a game controller 120. The visual hints are provided to the user as part of a sequence of inputs that is required to accomplish a particular task, for example. The sequence of inputs is defined by lighting up the input controls in a sequential order (e.g., a-d) to allow the user to follow the same sequence. The sequence of inputs can include double clicks of a button and/or sequence of button presses on an input device, such as controller 120. In the example illustrated in FIG. 4C, the hints include a double click of button 1 (shown by two concentric grey circles represented by ‘a’, ‘b’) followed by single press of buttons 5 and 6 (represented by ‘c’, ‘d’). The input sequence shown in FIG. 4C is an example and other combinations of input controls can also be envisioned.

FIG. 4D illustrates an example of haptic signal generated for a sequence of button presses on a controller 120, in one implementation. The haptic signals are provided in a specific order to allow the user to feel and follow the sequence of inputs expected for accomplishing a specific task at a game level of the video game. The input sequence shown in FIG. 4D instructs the user to press buttons 4 (‘a’) followed by button 1, 5 and 6, in that order. The hints provided in FIGS. 4A-4D are examples and that other types of hints and other formats, such as aural format can also be envisioned.

The various implementations define ways to detect the input capabilities of the user, determine the effectiveness of the user's input capabilities by determining the progress of the user in the video game, and provide recommendations to the user to improve their input capabilities to have a satisfactory gameplay experience. The recommendations can be tailored (i.e., customized) based on the user's input capabilities and can be provided in formats that the user desires so that the user can use the recommendations to improve their gameplay experience. For example, a first user may desire to have the recommendation provided in a visual format while a second user may desire to have the recommendation provided in an aural format and a third user may desire to have the recommendation provided as an instructional video. Similarly, different users may have different comfort levels for providing inputs (e.g., faster inputs vs. slower inputs, etc.). The user guidance engine 122 takes into consideration the various requirements for providing the hints to the user (e.g., type of hints, format, amount, frequency, etc.,) and generates the hints accordingly. Additionally, the hints can be provided to the user gradually based on the game level of the user in the video game. For example, fewer hints can be provided at the beginning game levels and as the game levels get complicated, greater number of hints can be provided. Alternately, as the user reaches higher game levels, fewer hints may be provided to assist the user in progressing in the game. The number and frequency of hints provided to the user may be determined based on the type and qualify of user inputs provided by the user and the game level of the user. As the user begins to progress to higher game levels indicating the user's mastery of the game challenges, fewer hints may be provided to the user, leading to the user having a satisfactory gameplay experience.

Other advantages will be realized by one skilled in the art after reading the various implementations of the disclosure.

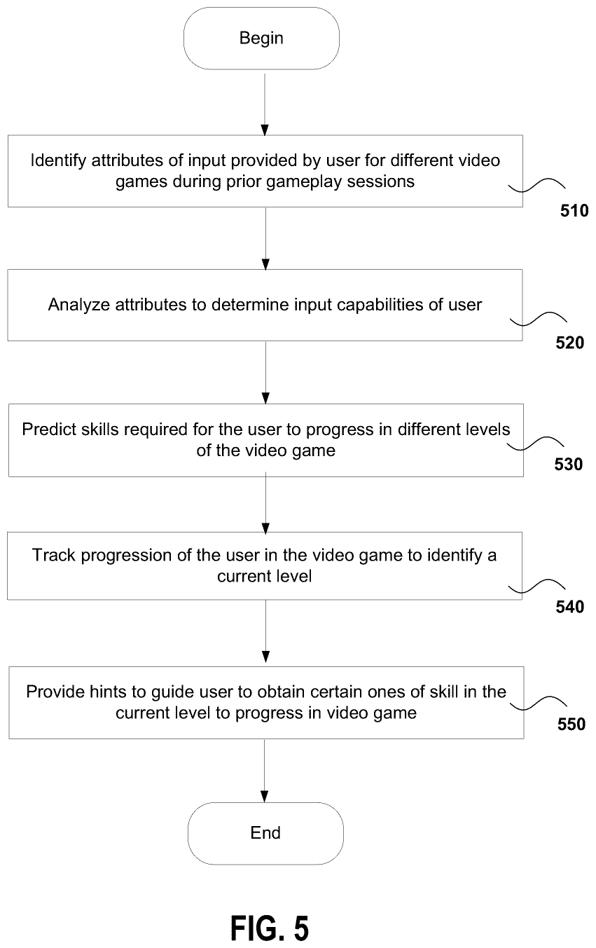

FIG. 5 illustrates flow operations of a method for providing assistance to a user for playing a video game, in one implementation. The method begins at operation 510, wherein attributes are identified from inputs provided by the user during prior gameplay sessions. In some implementations, the inputs used to identify the attributes correspond to the video game that the user selected for gameplay. In alternate implementations, the inputs used to identify attributes correspond to a plurality of video games. The inputs provided to the video game or the plurality of video games is analyzed to determine the user's comfort level and the input capabilities of the user, as illustrated in operation 520. The inputs from the video game can be used to determine the user's comfort level in tackling the various tasks in each level specific to the video game, while the inputs from the plurality of video games can be used to understand the generic input capabilities of the user (i.e., not restricted to a single video game). The generic input capabilities can be used to identify which types of inputs the user is comfortable handling and which types of inputs the user is struggling with. For example, the generic input capabilities can show the user being comfortable handling input sequence but not an input speed or vice versa.

The user's progression in the video game is tracked during current game play to identify the current level of the video game the user is currently interacting with and the inputs of the user that got the user to current level, as illustrated in operation 530. The current level and the inputs can be used to determine if the user is struggling with a certain level of the video game or the video game in general and the types of inputs the user is comfortable or struggling. The user's progression in the video game, the input capabilities of the user, and user inputs during current gameplay session of the video game are used to predict skills required for the user to progress to each level of the video game, as illustrated in operation 540. In some implementations, as the user plays the video game more frequently, the user can become more comfortable providing certain types of inputs that they were seen to be previously struggling and certain types of inputs the user continues to struggle with. Consequently, considering the input capabilities of the user determined from prior game play sessions, the user's inputs in the current gameplay session, and the input requirements specified for progressing in each level of the game, the user guidance engine 122 can identify the current comfort level of the user so as to be able to provide proper and timely hints. As the user may have mastered certain types of inputs that they were previously struggling with by frequently playing the video game, the user may not wish to receive hints pertaining to these certain types of inputs. Instead, the user may have progressed to higher levels and may be struggling with other types of inputs. Thus, by considering the user inputs to the video game from the current gameplay session and from prior gameplay sessions, the user guidance engine 122 can recognize the current struggles or comfort level of the user and provide appropriate hints to acquire game skills the user needs or is lacking to accomplish the challenges in different levels of the video game.

Based on the predicted skills required for the user to progress in each level, appropriate hints are identified and provided to the user to assist the user to progress in the video game, as illustrated in operation 550. The hints are provided to guide the user to acquire the game skills required to progress in a specific game level, including where, when and how the game skills can be acquired by the user. In some implementations, the hints are provided by predictively determining skills required by the user in some later game level and instructing the user to obtain the required skills in an earlier game level so that the user will be prepared to tackle and accomplish the challenges in the later game level. The hints provided to the user are customized in accordance to the input capabilities of the user so that the user will be able to easily follow the hints to acquire the necessary skills and progress in the video game.

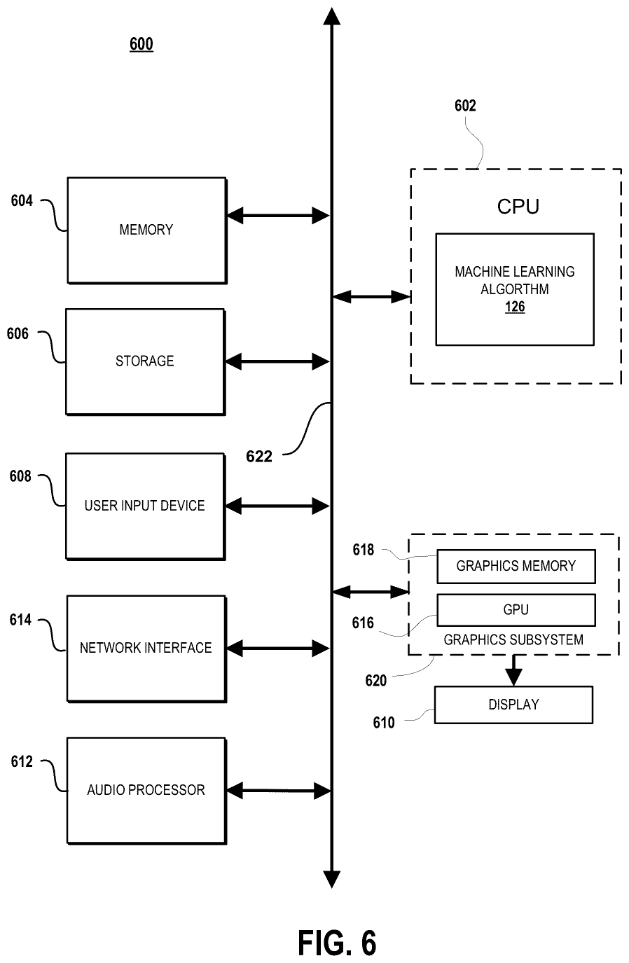

FIG. 6 illustrates components of an example computing device 600 that can be used to perform aspects of the various embodiments of the present disclosure. This block diagram illustrates computing device 600 that can incorporate or can be a personal computer, video game console, personal digital assistant, a head mounted display (HMD), a wearable computing device, a laptop or desktop computing device, a server or any other digital device, suitable for practicing an embodiment of the disclosure. For example, the device 600 represents a first device as well as a second device in various implementations discussed herein. Device 600 includes a central processing unit (CPU) 602 for running software applications and optionally an operating system. Further, the CPU 602 can include machine learning algorithm 122 with an object recognition algorithm (not shown) embedded therein to use the physical attributes captured for the real-world object in order to identify the real-world object. CPU 602 may be comprised of one or more homogeneous or heterogeneous processing cores. For example, CPU 602 is one or more general-purpose microprocessors having one or more processing cores. Further embodiments can be implemented using one or more CPUs with microprocessor architectures specifically adapted for highly parallel and computationally intensive applications, such as processing operations of interpreting a query, identifying contextually relevant resources, and implementing and rendering the contextually relevant resources in a video game immediately. Device 600 may be localized to a player playing a game segment (e.g., game console), or remote from the player (e.g., back-end server processor), or one of many servers using virtualization in a game cloud system for remote streaming of game play to client devices.

Memory 604 stores applications and data for use by the CPU 602. Storage 606 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 608 communicate user inputs from one or more users to device 600, examples of which may include keyboards, mice, joysticks, touch pads, touch screens, still or video recorders/cameras, tracking devices for recognizing gestures, and/or microphones. Network interface 614 allows device 600 to communicate with other computer systems via an electronic communications network, and may include wired or wireless communication over local area networks and wide area networks such as the internet. An audio processor 612 is adapted to generate analog or digital audio output from instructions and/or data provided by the CPU 602, memory 604, and/or storage 606. The components of device 600, including CPU 602, memory 604, data storage 606, user input devices 608, network interface 610, and audio processor 612 are connected via one or more data buses 622.

A graphics subsystem 620 is further connected with data bus 622 and the components of the device 600. The graphics subsystem 620 includes a graphics processing unit (GPU) 616 and graphics memory 618. Graphics memory 618 includes a display memory (e.g., a frame buffer) used for storing pixel data for each pixel of an output image. Graphics memory 618 can be integrated in the same device as GPU 616, connected as a separate device with GPU 616, and/or implemented within memory 604. Pixel data can be provided to graphics memory 618 directly from the CPU 602. Alternatively, CPU 602 provides the GPU 616 with data and/or instructions defining the desired output images, from which the GPU 616 generates the pixel data of one or more output images. The data and/or instructions defining the desired output images can be stored in memory 604 and/or graphics memory 618. In an embodiment, the GPU 616 includes 3D rendering capabilities for generating pixel data for output images from instructions and data defining the geometry, lighting, shading, texturing, motion, and/or camera parameters for a scene. The GPU 616 can further include one or more programmable execution units capable of executing shader programs.

The graphics subsystem 620 periodically outputs pixel data for an image from graphics memory 618 to be displayed on display device 610. Display device 610 can be any device capable of displaying visual information in response to a signal from the device 600, including CRT, LCD, plasma, and OLED displays. In addition to display device 610, the pixel data can be projected onto a projection surface. Device 600 can provide the display device 610 with an analog or digital signal, for example.

It should be noted, that access services, such as providing access to games of the current embodiments, delivered over a wide geographical area often use cloud computing. Cloud computing is a style of computing in which dynamically scalable and often virtualized resources are provided as a service over the Internet. Users do not need to be an expert in the technology infrastructure in the “cloud” that supports them. Cloud computing can be divided into different services, such as Infrastructure as a Service (IaaS), Platform as a Service (PaaS), and Software as a Service (SaaS). Cloud computing services often provide common applications, such as video games, online that are accessed from a web browser, while the software and data are stored on the servers in the cloud. The term cloud is used as a metaphor for the Internet, based on how the Internet is depicted in computer network diagrams and is an abstraction for the complex infrastructure it conceals.

A game server may be used to perform the operations of the durational information platform for video game players, in some embodiments. Most video games played over the Internet operate via a connection to the game server. Typically, games use a dedicated server application that collects data from players and distributes it to other players. In other embodiments, the video game may be executed by a distributed game engine. In these embodiments, the distributed game engine may be executed on a plurality of processing entities (PEs) such that each PE executes a functional segment of a given game engine that the video game runs on. Each processing entity is seen by the game engine as simply a compute node. Game engines typically perform an array of functionally diverse operations to execute a video game application along with additional services that a user experiences. For example, game engines implement game logic, perform game calculations, physics, geometry transformations, rendering, lighting, shading, audio, as well as additional in-game or game-related services. Additional services may include, for example, messaging, social utilities, audio communication, game play/replay functions, help function, etc. While game engines may sometimes be executed on an operating system virtualized by a hypervisor of a particular server, in other embodiments, the game engine itself is distributed among a plurality of processing entities, each of which may reside on different server units of a data center.

According to this embodiment, the respective processing entities for performing the operations may be a server unit, a virtual machine, or a container, depending on the needs of each game engine segment. For example, if a game engine segment is responsible for camera transformations, that particular game engine segment may be provisioned with a virtual machine associated with a graphics processing unit (GPU) since it will be doing a large number of relatively simple mathematical operations (e.g., matrix transformations). Other game engine segments that require fewer but more complex operations may be provisioned with a processing entity associated with one or more higher power central processing units (CPUs).

By distributing the game engine, the game engine is provided with elastic computing properties that are not bound by the capabilities of a physical server unit. Instead, the game engine, when needed, is provisioned with more or fewer compute nodes to meet the demands of the video game. From the perspective of the video game and a video game player, the game engine being distributed across multiple compute nodes is indistinguishable from a non-distributed game engine executed on a single processing entity, because a game engine manager or supervisor distributes the workload and integrates the results seamlessly to provide video game output components for the end user.

Users access the remote services with client devices, which include at least a CPU, a display and I/O. The client device can be a PC, a mobile phone, a netbook, a PDA, etc. In one embodiment, the network executing on the game server recognizes the type of device used by the client and adjusts the communication method employed. In other cases, client devices use a standard communications method, such as html, to access the application on the game server over the internet.

It should be appreciated that a given video game or gaming application may be developed for a specific platform and a specific associated controller device. However, when such a game is made available via a game cloud system as presented herein, the user may be accessing the video game with a different controller device. For example, a game might have been developed for a game console and its associated controller, whereas the user might be accessing a cloud-based version of the game from a personal computer utilizing a keyboard and mouse. In such a scenario, the input parameter configuration can define a mapping from inputs which can be generated by the user's available controller device (in this case, a keyboard and mouse) to inputs which are acceptable for the execution of the video game.

In another example, a user may access the cloud gaming system via a tablet computing device, a touchscreen smartphone, or other touchscreen driven device. In this case, the client device and the controller device are integrated together in the same device, with inputs being provided by way of detected touchscreen inputs/gestures. For such a device, the input parameter configuration may define particular touchscreen inputs corresponding to game inputs for the video game. For example, buttons, a directional pad, or other types of input elements might be displayed or overlaid during running of the video game to indicate locations on the touchscreen that the user can touch to generate a game input. Gestures such as swipes in particular directions or specific touch motions may also be detected as game inputs. In one embodiment, a tutorial can be provided to the user indicating how to provide input via the touchscreen for gameplay, e.g., prior to beginning gameplay of the video game, so as to acclimate the user to the operation of the controls on the touchscreen.

In some embodiments, the client device serves as the connection point for a controller device. That is, the controller device communicates via a wireless or wired connection with the client device to transmit inputs from the controller device to the client device. The client device may in turn process these inputs and then transmit input data to the cloud game server via a network (e.g., accessed via a local networking device such as a router). However, in other embodiments, the controller can itself be a networked device, with the ability to communicate inputs directly via the network to the cloud game server, without being required to communicate such inputs through the client device first. For example, the controller might connect to a local networking device (such as the aforementioned router) to send to and receive data from the cloud game server. Thus, while the client device may still be required to receive video output from the cloud-based video game and render it on a local display, input latency can be reduced by allowing the controller to send inputs directly over the network to the cloud game server, bypassing the client device.

In one embodiment, a networked controller and client device can be configured to send certain types of inputs directly from the controller to the cloud game server, and other types of inputs via the client device. For example, inputs whose detection does not depend on any additional hardware or processing apart from the controller itself can be sent directly from the controller to the cloud game server via the network, bypassing the client device. Such inputs may include button inputs, joystick inputs, embedded motion detection inputs (e.g., accelerometer, magnetometer, gyroscope), etc. However, inputs that utilize additional hardware or require processing by the client device can be sent by the client device to the cloud game server. These might include captured video or audio from the game environment that may be processed by the client device before sending to the cloud game server. Additionally, inputs from motion detection hardware of the controller might be processed by the client device in conjunction with captured video to detect the position and motion of the controller, which would subsequently be communicated by the client device to the cloud game server. It should be appreciated that the controller device in accordance with various embodiments may also receive data (e.g., feedback data) from the client device or directly from the cloud gaming server.

In one embodiment, the various technical examples can be implemented using a virtual environment via a head-mounted display (HMD). An HMD may also be referred to as a virtual reality (VR) headset. As used herein, the term “virtual reality” (VR) generally refers to user interaction with a virtual space/environment that involves viewing the virtual space through an HMD (or VR headset) in a manner that is responsive in real-time to the movements of the HMD (as controlled by the user) to provide the sensation to the user of being in the virtual space or metaverse. For example, the user may see a three-dimensional (3D) view of the virtual space when facing in a given direction, and when the user turns to a side and thereby turns the HMD likewise, then the view to that side in the virtual space is rendered on the HMD. An HMD can be worn in a manner similar to glasses, goggles, or a helmet, and is configured to display a video game or other metaverse content to the user. The HMD can provide a very immersive experience to the user by virtue of its provision of display mechanisms in close proximity to the user's eyes. Thus, the HMD can provide display regions to each of the user's eyes which occupy large portions or even the entirety of the field of view of the user, and may also provide viewing with three-dimensional depth and perspective.

In one embodiment, the HMD may include a gaze tracking camera that is configured to capture images of the eyes of the user while the user interacts with the VR scenes. The gaze information captured by the gaze tracking camera(s) may include information related to the gaze direction of the user and the specific virtual objects and content items in the VR scene that the user is focused on or is interested in interacting with. Accordingly, based on the gaze direction of the user, the system may detect specific virtual objects and content items that may be of potential focus to the user where the user has an interest in interacting and engaging with, e.g., game characters, game objects, game items, etc.

In some embodiments, the HMD may include an externally facing camera(s) that is configured to capture images of the real-world space of the user such as the body movements of the user and any real-world objects that may be located in the real-world space. In some embodiments, the images captured by the externally facing camera can be analyzed to determine the location/orientation of the real-world objects relative to the HMD. Using the known location/orientation of the HMD, the real-world objects, and inertial sensor data from the Inertial Motion Unit (IMU) sensors, the gestures and movements of the user can be continuously monitored and tracked during the user's interaction with the VR scenes. For example, while interacting with the scenes in the game, the user may make various gestures such as pointing and walking toward a particular content item in the scene. In one embodiment, the gestures can be tracked and processed by the system to generate a prediction of interaction with the particular content item in the game scene. In some embodiments, machine learning may be used to facilitate or assist in said prediction.

During HMD use, various kinds of single-handed, as well as two-handed controllers can be used. In some implementations, the controllers themselves can be tracked by tracking lights included in the controllers, or tracking of shapes, sensors, and inertial data associated with the controllers. Using these various types of controllers, or even simply hand gestures that are made and captured by one or more cameras, it is possible to interface, control, maneuver, interact with, and participate in the virtual reality environment or metaverse rendered on an HMD. In some cases, the HMD can be wirelessly connected to a cloud computing and gaming system over a network. In one embodiment, the cloud computing and gaming system maintains and executes the video game being played by the user. In some embodiments, the cloud computing and gaming system is configured to receive inputs from the HMD and the interface objects over the network. The cloud computing and gaming system is configured to process the inputs to affect the game state of the executing video game. The output from the executing video game, such as video data, audio data, and haptic feedback data, is transmitted to the HMD and the interface objects. In other implementations, the HMD may communicate with the cloud computing and gaming system wirelessly through alternative mechanisms or channels such as a cellular network.

Additionally, though implementations in the present disclosure may be described with reference to a head-mounted display, it will be appreciated that in other implementations, non-head mounted displays may be substituted, including without limitation, portable device screens (e.g. tablet, smartphone, laptop, etc.) or any other type of display that can be configured to render video and/or provide for display of an interactive scene or virtual environment in accordance with the present implementations. It should be understood that the various embodiments defined herein may be combined or assembled into specific implementations using the various features disclosed herein. Thus, the examples provided are just some possible examples, without limitation to the various implementations that are possible by combining the various elements to define many more implementations. In some examples, some implementations may include fewer elements, without departing from the spirit of the disclosed or equivalent implementations.

As noted, embodiments of the present disclosure for communicating between computing devices may be practiced using various computer device configurations including hand-held devices, microprocessor systems, microprocessor-based or programmable consumer electronics, minicomputers, mainframe computers, head-mounted display, wearable computing devices and the like. Embodiments of the present disclosure can also be practiced in distributed computing environments where tasks are performed by remote processing devices that are linked through a wire-based or wireless network.

In some embodiments, communication may be facilitated using wireless technologies. Such technologies may include, for example, 5G wireless communication technologies. 5G is the fifth generation of cellular network technology. 5G networks are digital cellular networks, in which the service area covered by providers is divided into small geographical areas called cells. Analog signals representing sounds and images are digitized in the telephone, converted by an analog to digital converter and transmitted as a stream of bits. All the 5G wireless devices in a cell communicate by radio waves with a local antenna array and low power automated transceiver (transmitter and receiver) in the cell, over frequency channels assigned by the transceiver from a pool of frequencies that are reused in other cells. The local antennas are connected with the telephone network and the Internet by a high bandwidth optical fiber or wireless backhaul connection. As in other cell networks, a mobile device crossing from one cell to another is automatically transferred to the new cell. It should be understood that 5G networks are just an example type of communication network, and embodiments of the disclosure may utilize earlier generation wireless or wired communication, as well as later generation wired or wireless technologies that come after 5G.

With the above embodiments in mind, it should be understood that the disclosure can employ various computer-implemented operations involving data stored in computer systems. These operations are those requiring physical manipulation of physical quantities. Any of the operations described herein that form part of the disclosure are useful machine operations. The disclosure also relates to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

Although the method operations were described in a specific order, it should be understood that other housekeeping operations may be performed in between operations, or operations may be adjusted so that they occur at slightly different times or may be distributed in a system which allows the occurrence of the processing operations at various intervals associated with the processing, as long as the processing of the telemetry and game state data for generating modified game states are performed in the desired way.

One or more embodiments can also be fabricated as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

It should be understood that the various embodiments defined herein may be combined or assembled into specific implementations using the various features disclosed herein. Thus, the examples provided are just some possible examples, without limitation to the various implementations that are possible by combining the various elements to define many more implementations. In some examples, some implementations may include fewer elements, without departing from the spirit of the disclosed or equivalent implementations.

1. A method for providing assistance to a user for playing a video game, comprising:
identifying attributes of inputs provided by the user during prior gameplay sessions of a plurality of video games, the attributes identified by analyzing the inputs retrieved from historical game data of the user, wherein the plurality of video games includes the video game;
analyzing the attributes of the inputs to determine input capabilities exhibited by the user during prior gameplay sessions of the plurality of video games;
tracking progression of the user in the video game during a current gameplay session to identify a current level of the video game of the user and the inputs provided by the user during the current gameplay session;
predicting skills required for the user to progress to each level of the video game, wherein the prediction is based on the input capabilities of the user, input requirements specified for said each level of the video game, and the inputs provided by the user in current gameplay session; and
providing hints to guide the user to obtain certain ones of the skills at said current level of the video game to assist the user to progress in the video game, the hints are customized in accordance to the input capabilities of the user and the inputs provided by the user in the current gameplay session,
wherein operations of the method are performed by a processor of a computing system executing the video game.

2. The method of claim 1, wherein the hints are customized based on a current level of the video game of the user in the current gameplay session.

3. The method of claim 1, wherein the input capabilities determined from the attributes of the input include a type of game asset possessed by the user, skill of the user in maneuvering the game asset, a type of input device used, type of input provided using the input device including speed of button press, sequence of button presses, combination of button presses, or any combinations thereof.

4. The method of claim 1, wherein predicting skills includes,
identifying the input requirements for achieving a specific level of the video game, the input requirements specifying game input capabilities required from the user to achieve the specific level of the video game; and
comparing the input capabilities currently possessed by the user with the game input capabilities needed for achieving the specific level of the video game, the comparison used to identify the certain ones of the skills of the user needed at the specific level of the video game.

5. The method of claim 4, wherein the input requirements is a game asset, and
wherein predicting skills include identifying the game asset required for achieving the specific level of the video game and a first game level where the game asset is available, the identification of the first game level used to generate a signal to the user to obtain the game asset from the first game level for use in the specific level of the game, wherein the first game level occurs earlier in the video game than the specific level.

6. The method of claim 5, wherein the predicting of skills required in a later occurring specific level and availability of the game asset in an earlier occurring first game level is done using a machine learning algorithm, and wherein the signal is an informative message.

7. The method of claim 4, wherein the input requirements includes certain sequence of inputs that has to be provided to progress in the specific level of the video game, and
wherein providing hints includes providing the user with the certain sequence of inputs required for progressing in the specific level of the video game.

8. The method of claim 7, wherein the hints are provided as any one or a combination of, (a) visual hints using images of inputs on a graphic user interface rendered on a display screen alongside content of the video game, or (b) a haptic response using inputs of an input device, or (c) an aural command issued through a speaker associated with a client device used for rendering content of the video game, or (d) a textual content on a text-based user interface, or (e) a training video illustrating sequence of inputs.

9. The method of claim 1, wherein customizing the hints include,
customizing a frequency or a quantity of hints provided to the user at each level during gameplay of the video game, based on a complexity of said each level.

10. The method of claim 9, wherein customizing the hints includes gradually increasing the frequency or the quantity of hints based on amount of progress made by the user in the video game,

11. The method of claim 9, wherein the frequency or the quantity of hints provided at each level is based on a level of complexity at said each level of the video game.

12. The method of claim 1, wherein providing the hints includes identifying and providing one or more recollection metrics for the video game to assist the user in recollecting details of the video game, the recollection metrics providing relevant data that is specific for the user to recollect any one or combination of purpose, goals, story points, weapons required in different levels, inputs required to overcome challenges, user customization of inputs, dialogs exchanged between the user and other players, dialogs exchanged between the user and spectators, dialogs exchanged between the user and a coach.

13. The method of claim 1, wherein providing the hints is triggered in response to receiving a request for assistance from the user.

14. A method for providing assistance to a user for playing a video game, comprising:
identifying attributes of inputs provided by the user during prior gameplay sessions of a plurality of video games, the attributes identified by analyzing the inputs retrieved from historical game data of the user, wherein the plurality of video games includes the video game;
analyzing the attributes of the inputs to determine input capabilities exhibited by the user during prior gameplay sessions of the plurality of video games;
identifying a specific area of gameplay of the video game where the user requires assistance to progress in the video game, based on the input capabilities of the user; and
providing hints to assist the user to progress in the specific area of gameplay of the video game, the hints customized in accordance to the input capabilities of the user and based on a game state of the video game in the current gameplay session,
wherein operations of the method are performed by a processor of a computing system executing the video game.

15. The method of claim 14, wherein identifying specific areas of gameplay includes,
building a user skills matrix using input capabilities exhibited by the user when accomplishing each task in each level during prior gameplay sessions of the video game, the input capabilities represent skills of the user in performing said each task at said each level of the video game; and
comparing the user skills matrix of the user with a corresponding game skills matrix generated for the video game to identify the specific area within a level of the video game where the input capabilities of the user prevent the user from accomplishing a task for progressing in said level,
wherein the game skills matrix is generated using inputs required to accomplish each task in order to progress in each level of the video game, and
wherein comparing the matrices includes comparing each entry of the game skills matrix with corresponding entry in said user skills matrix to identify one or more differences, the entry identifying the specific area of gameplay that the user has to improve their skills.

16. The method of claim 14, wherein the input capabilities include a game asset required for progressing in the specific area, and
wherein providing the hints includes generating a signal to guide the user in obtaining the game asset for progressing in the specific area.

17. The method of claim 14, wherein customizing the hints includes,
customizing a frequency or a quantity of hints provided to the user for progressing at each level of the video game, wherein the frequency or the quantity based on a complexity of said each level and the input capabilities of the user.

18. The method of claim 14, wherein customizing the hints includes gradually increasing the frequency or the quantity of hints, based on amount of progress made by the user and complexity of gameplay at said each level of the video game.

19. The method of claim 14, wherein providing the hints includes identifying and providing one or more recollection metrics for the video game to assist the user in recollecting details of the video game, the recollection metrics providing relevant data that is specific for the user to recollect any one or combination of purpose, goals, story points, weapons required in different levels, inputs required to overcome challenges, user customization of inputs, dialogs exchanged between the user and other players, dialogs exchanged between the user and spectators, dialogs exchanged between the user and a coach.
